(19) United States
(12) Patent Application Publication
(10) Pub. No.: US 2012/0141850 A1
(43) Pub. Date: Jun. 7, 2012

(54) MIDDLE OR LARGE SIZED BATTERY

(75) Inventor: Byung Jo JEONG, Hwaseong (KR)

(73) Assignees: KIA MOTORS CORPORATION, Seoul (KR); HYUNDAI MOTOR COMPANY, Seoul (KR)

(21) Appl. No.: 13/031,373

(22) Filed: Feb. 21, 2011

(30) Foreign Application Priority Data
Dec. 3, 2010 (KR) 10-2010-0122443

(51) Int. Cl. H01M 10/36

(52) U.S. Cl. 429/94

(57) ABSTRACT

Disclosed herein is a middle or large sized battery, more particularly, a middle or large sized battery that provides improved volume energy density provides an advantageous structure for preparing an end cell with large capacity, particularly by improving the structure of a can and internal connecting system of positive and negative electrodes in the middle or large sized battery. According to the present invention, a middle or large sized battery is provided which comprises a can having an open portion formed on two opposing sides; an electrode jelly roll disposed inside the can, and comprising a current collector of positive electrode, a separator, and a current collector of negative electrode being stacked in turn and wound therein; a lead tab connected to the current collector of positive and negative electrodes of opposing sides in the electrode jelly roll; and a lateral cap assembly electrically in contact with the lead tab and coupled to the opposing sides of the can.

### CROSS-REFERENCE TO RELATED APPLICATION

This application claims under 35 U.S.C. §119(a) the benefit of Korean Patent Application No. 10-2010-0122443 filed Dec. 3, 2010, the entire contents of which are incorporated herein by reference.

### BACKGROUND

1. Technical Field

The present invention generally relates to a middle or large sized battery. More particularly, it relates to a middle or large sized battery that is provided with improved volume energy density and which has an advantageous structure for preparing an end cell with large capacity, by improving the structure of a can and internal connecting system of positive and negative electrodes in the middle or large sized battery.

2. Background Art

Batteries are used in a variety of fields, and generally are devices which convert chemical energy generated in an electrochemical oxidation-deoxidation reaction into electric energy. Middle and large sized batteries which are high in current and power are used, in particular, for electric vehicles and the like. Methods for improving the energy density of such middle and large sized batteries would, thus, be desirable.

FIG. 7 illustrates a structure and a process for preparing a middle or large sized battery in the relevant art. As shown in FIG. 7, first a current collector of positive electrode 10, a separator (not shown), and a current collector of negative electrode 12 may be stacked in turn (FIG. 7(a)) to thereby prepare an electrode jelly roll 20 after winding in the shape of roll (FIG. 7(b)). At this time, the ends in the current collectors of positive and negative electrodes 10, 12 may be projected to both sides of the jelly roll 20 (i.e. may protrude from or extend beyond the sides of the jelly roll 20) since the current collector of positive electrode 10 and current collector of negative electrode 12 may be stacked in zigzags for a predetermined interval of the winding.

Next, the ends in the current collectors of positive and negative electrodes 10, 12 which project to both sides of the jelly roll 20, and the lead tab framework 22a, 22b (FIG. 7(c)) may be welded. The welded material is then inserted inside the can (i.e. battery case 30) which, as shown, may be in a suitable shape with an open top. Next, an upper cap assembly (not shown) is assembled, and a coupling portion between the can 30 and the upper cap assembly is welded to thereby prepare the middle or large sized battery.

The can 30 used in prior middle or large sized batteries is illustrated, for example, in FIG. 8. As shown, the can 30 has a generally square-like shape with an open top. Such conventional cans are generally formed by a method for molding soft aluminum, particularly by applying a deep drawing process. Namely, based on the use of soft aluminum 1 as material, an oil-pressure press process is applied several times (particularly multiples of ten), to thereby prepare the can 30 in the square-like shape with the open top.

However, this structure of prior middle or large sized batteries has multiple problems.

Firstly, use of soft aluminum as a material results in a weakness in strength of the can, particularly since such a top open-type can is prepared by a deep drawing process. In order to ensure the strong property of the can, the bottom and lateral sides should be thick. However, this increases the weight of the can, and disadvantageously reduces the energy density against the volume. Especially, in the case of increasing the electric capacity in a battery cell, the size of the can may be increased so as to ensure the strong property of the can and reduce the percent of defective cans in preparation. However, the need to increase thickness in the bottom and lateral sides of the can is particularly difficult to apply to large sized batteries.

Secondly, in the case of applying the deep drawing method, several times (particularly multiples of ten) of oil-pressure processes are needed, which requires excessive costs of processing and, further, results in a high percentage of defectively prepared cans. In particular, crack are often generated in the edges of the cans, which results in production of defective cans and increases in the unit cost of the cans.

Thirdly, the prior structure of middle and large sized batteries is disadvantageous in that the battery volume increases due to the space for accommodating the lead tabs (e.g. 22a, 22b) formed on both sides of the jelly roll. That is, referring to FIG. 7 such a structure requires additional space for the lead tabs to be provided on both sides of the jelly roll, which reduces volume energy density of the battery, while the lead tabs coupled with the ends in the current collector of positive and negative electrodes projected to both sides of the jelly roll are projected to the open portion of the top in the can, as shown, for example, in FIG. 7(e).

There remains a need in the art for providing middle and large sized batteries having improved energy density.

### SUMMARY OF THE DISCLOSURE

Accordingly, the present invention provides an improved battery, particularly an improved middle or large sized battery. In particular, the present invention provides middle and large sized batteries, wherein the can is formed from a molded metal material and is strong in property, and wherein the battery volume is reduced. In particular, the present invention provides a middle or large sized battery having an improved structure of the can and internal connecting system of positive and negative electrodes.

According to an embodiment of the invention, a middle or large sized battery comprises a can having an open portion formed on two sides: an electrode jelly roll disposed inside the can, the electric jelly roll comprising a current collector of positive electrode, a separator, and a current collector of negative electrode being stacked in turn and wound therein; a lead tab connected to each of the current collector of positive electrode and current collector of negative electrode, wherein the current collector of positive electrode and current collector of negative electrode are preferably provided on or project from each side in the electrode jelly roll; and a lateral cap assembly electrically in contact with the lead tabs, and being coupled to the two sides of the can having an open portion.

According to various embodiments of the present invention, the lateral cap assembly may include a conductor plate having a coupling part for contact with a lead tab; and an insulating plate having a hole disposed therein which enables the coupling part and lead tab to come into contact with each other, wherein the insulator plate is and stacked between the can and the conductor plate.

According to some embodiments, the coupling part of the conductor plate may be projected towards the inner direction of the can to pass through the hole of the insulating plate and come into contact with the tab.

Further, in some embodiments a rubber pad may be further stacked between the lateral cap assembly and the sides of the can.

In accordance with some embodiments of the present invention, the shape of the lead tab may be adjustable, for example, by forming the lead tab of a flexible material or the like.

The middle or large sized battery according to the present invention may beneficially be prepared by methods other than the conventional die drawing method. For example, according to some embodiments, a die-casting or imprint process can be used. Such processes can be in accordance with known die-casting and imprint processes. Thus, according to the present invention, the can may be prepared using a metal material with strong property. As such, when strong metal materials are used, it is possible to form thin walls in the can, while still ensuring the strong property of the battery, in addition to reducing the weight of the battery.

Further, compared with cans prepared by the prior deep drawing method, the method in accordance with the present invention provides for decreased processing costs as well as a reduction in defectively produced cans.

Further, according to the present invention, it is possible to radically reduce the volume that the lead tabs occupy and to improve the volume energy density of the whole battery, particularly wherein the lead tabs on the lateral portions of the jelly roll are electrically connected with the cap assembly coupled to the sides of the can having an open portion (e.g. lateral sides of the can).

### BRIEF DESCRIPTION OF THE DRAWINGS

FIG. 1 is a constitutional view illustrating a can and a cap assembly of a middle or large sized battery according to an embodiment of the present invention.

FIG. 2 is a view illustrating the structure of the cap assembly of FIG. 1.

FIG. 3 is a view illustrating a structure and manufacturing process of the middle or large sized battery according to an embodiment of the present invention.

FIG. 4 is a view illustrating stacking of a rubber pad between the can and lateral cap assembly according to another embodiment of the present invention

FIG. 5 is a view illustrating a stacked structure of the rubber pad and lateral cap assembly according to an embodiment of the present invention.

FIG. 6 is a view illustrating a structure and manufacturing process of the middle or large sized battery according to another embodiment of the present invention.

FIG. 7 is a view illustrating a structure and manufacturing process of the middle or large sized battery according to the prior art.

FIG. 8 is a view illustrating a manufacturing process of the can in the middle or large sized battery according to the prior art.

### DETAILED DESCRIPTION

In order that the invention may be fully understood, preferred embodiments thereof will now be described with reference to the accompanying drawings.

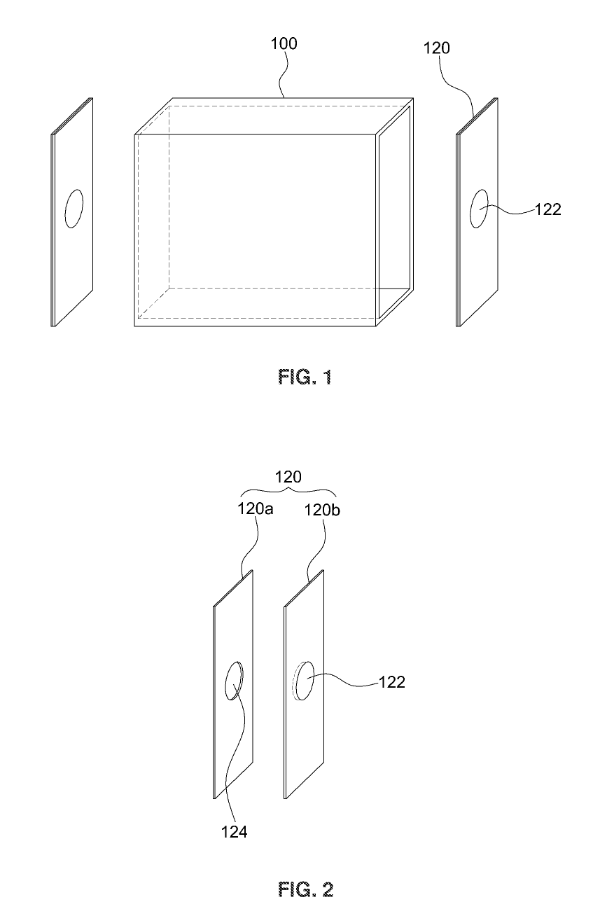

FIG. 1 to FIG. 3 illustrates a structure and manufacturing process of the middle or large sized battery according to an embodiment of the present invention.

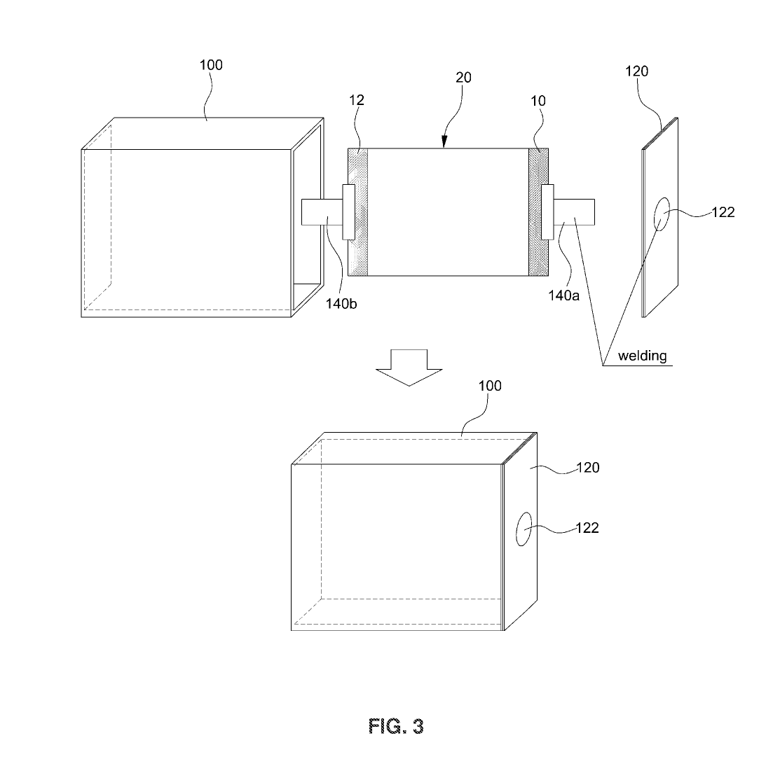

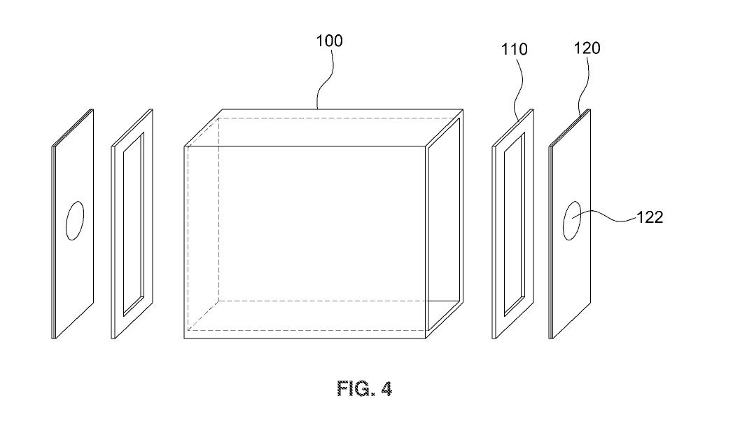

FIG. 1 illustrates a can 100 and a lateral cap assembly of a battery according to an embodiment of the present invention, and FIG. 2 illustrates the structure of the cap assembly. Further, FIG. 3 illustrates an assembling process of the can 100 the lateral cap assembly 120 of FIGS. 1 and 2, and an electrode jelly-roll 20 according to an embodiment of the present invention.

As illustrated, the middle or large sized battery according to an embodiment of the present invention may include the can 100, the electrode jelly-roll 20, the lateral cap assembly 120 and lead tabs 140a, 140b.

As shown in the figures, the can 100 has two open sides, for example both lateral sides may be open, thereby forming a space for accommodating the electrode jelly roll 20 according to an embodiment of the present invention. Therefore, the can 100 may be prepared by a variety of methods such as die-casting or imprint processing, and such methods can be carried out using metals with strong property. As such, it is possible to form a thin-walled can while still providing the can with strength as needed. For example, the can 100 may be made of aluminum according to an embodiment of the present invention, and according to another embodiment, hard aluminum with high magnesium content may be used to prepare the can. According to further embodiments, materials such as iron and stainless steel may be used to prepare the can.

The electrode jelly roll 20 can be in accordance with those conventionally used and is not particularly limited. For example, as conventionally prepared, a current collector of positive electrode 10, a separator (not shown) which can be in accordance with any known separators, and a current collector of negative electrode 12 are stacked in turn and wound to form the electrode jelly roll 20.

A lead tab 140a, 140b of the invention may be coupled to both sides of the electrode jelly roll 20. For example, as shown, the lead tabs 140a, 140b may be respectively connected to the end of the current collector of positive electrode 10 and current collector of negative electrode 12 which is protruded from the wound electrode jelly roll 20. According to some embodiments, the coupling between the tabs 140a, 140b and electrodes 10, 12 may be formed by welding or the like.

According to an embodiment of the present invention, one or more of the lead tabs 140a, 140b in contact with a coupling part 122 of the lateral cap assembly 120 may be configured such that it is possible to change its shape. For example, one or more of the lead tabs 140a, 140b can be made of soft material and may contact the coupling part 122 of the lateral cap assembly 120 such that the one or more tabs 140a, 140b can take on a curved shape as a result of the lateral cap assembly's 120 coupling to the can 100 (e.g. to the lateral side of the can 100.

As shown, for example, in FIG. 3, the lateral cap assembly 120 is coupled to both open sides of the can 100 thereby closing the can 100 and, at the same time, electrically connecting with the lead tabs 140a, 140b. According to one embodiment of the present invention, as illustrated in FIG. 2, a conductor plate 120b and an insulating plate 120a may be stacked to form the lateral cap assembly 120. The coupling part 122 for contacting with the lead tabs 140a, 140b inside the can 100 may be formed in the conductor plate 120b, and a hole 124 may be disposed in the insulating plate 120a through which the coupling part 122 and the lead tabs 140a, 140b may come into contact with each other.

Preferably, the coupling part 122 of the conductor plate 120b may be projected towards the interior of the can 100, and it may contact with the lead tabs 140a, 140b through a hole 124 of the insulating plate 120a.

In particular, when the insulating plate 120a and the conductor plate 120b are stacked, the projected coupling part 122 of the conductor plate 120b passes through the hole 124 of the insulating plate 120a, and the coupling part 122 may contact the lead tab 140a which is coupled to the side portion of the electrode jelly roll 20 disposed inside the can 100, as illustrated in FIG. 3. In FIG. 3, the lateral cap assembly 120 may be equipped in the right side of the can 100 as shown to contact lead tab 140a, and a further lateral cap assembly 120 can be provided in the same way in the left side of the can with the coupling part of the conductor plate 120b contacting the lead tab 140b.

According embodiments of the present invention, the coupling between the coupling part 122 and the lead tabs 140a, 140b may be further welded such that if, for example, the cap assembly 120 is separated from the can 100, the coupling between the coupling part 122 and the lead tabs 140a, 140b may be sustained. This sustained coupling can further be enhanced by configuring the lead tabs 140a, 140b with a flexible shape such that a change of their shape may be possible.

According to some embodiments, the welded and coupled cap assembly 120 is provided on the can through the lead tabs 140a, 140b such that when the lead tabs 140a, 140b contact and/or are pressed by the coupling part 122, the lead tabs 140a, 140b sustains the coupling with the coupling part 122 in a curved shape. Accordingly, the middle or large sized battery of the present invention can provide a reduced volume of the can 100, particularly by reducing the volume in which the lead tabs 140a, 140b may be equipped.

After the lateral cap assembly 120 is equipped in the sides of the can 100, it may be further coupled by laser welding or other suitable means.

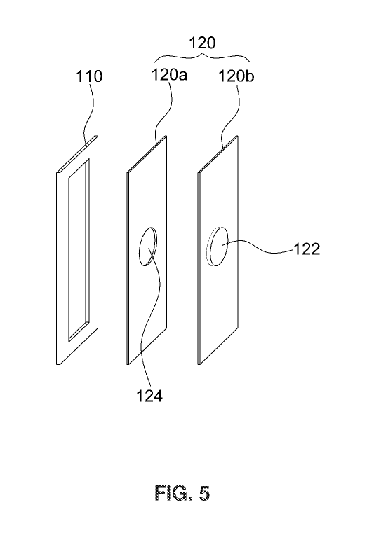

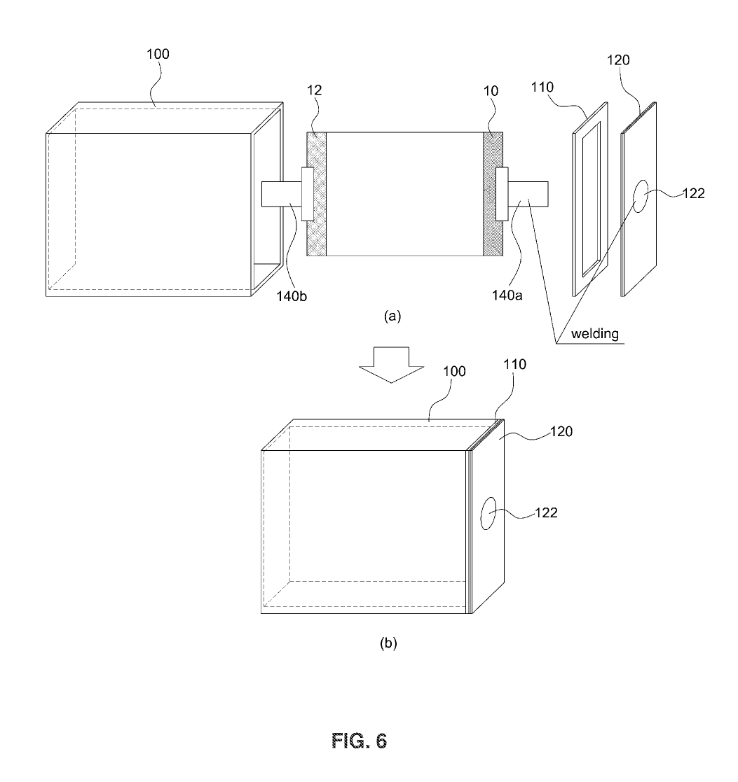

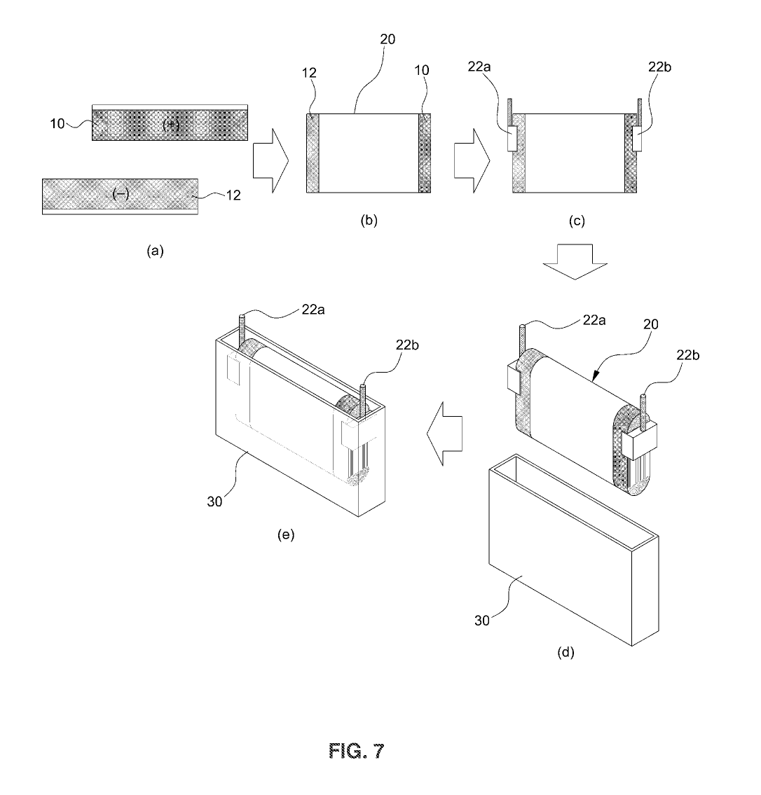

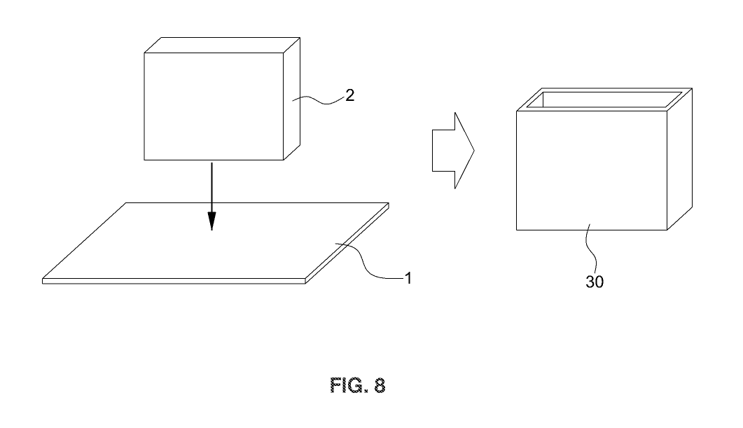

FIGS. 4 to 6 illustrates a structure and manufacturing process of the middle or large sized battery according to another embodiment of the present invention. It s noted that the detailed descriptions of FIGS. 4 to 6 correspond generally to that described in connection with the middle or large sized battery of FIGS. 1 to 3.

As illustrated in FIGS. 4 to 6, the middle or large sized battery according to another embodiment of the present invention may further comprise the rubber pad 110 for disposing between the lateral cap assembly 120 and one or both sides of the can 100. The rubber pad 110 preferably corresponds to the shape of the borders formed in the lateral open part of the can 100. According to some embodiments, the rubber pad 110 may be stacked between the lateral cap assembly 120 and both sides of the can 100 to assist in clamping or coupling between the can 100 and the lateral cap assembly 120. According to some embodiments, when the rubber pad 110 is disposed as shown and described, the coupling between the can 100 and the lateral cap assembly 120 may be realized without requiring additional welding.

According to some embodiments, the rubber pad 110 may be configured so as to sustain coupling between the can 100 and the lateral cap assembly 120, and can further fix the electrode jelly roll 20 disposed inside the can 100, for example, such that the electrode jelly roll 20 is prevented from being shaken by external shock.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A middle or large sized battery comprising:
a can having an open portion formed on each of two opposing sides;
an electrode jelly roll disposed inside the can, the electrode jelly roll comprising a current collector of positive electrode, a separator, and a current collector of negative electrode stacked in turn and wound;
a lead tab connected to the current collector of positive electrode and the current collector of negative electrodes disposed on opposing sides of the electrode jelly roll; and
a lateral cap assembly disposed on each of the two opposing sides of the can and being in electrical contact with the lead tab.

2. The middle or large sized battery according to claim 1, wherein the lateral cap assembly includes a conductor plate having a coupling part for contacting with the lead tab; and an insulating plate having a hole disposed therein,
wherein the insulating plate is disposed between the can and the conductor plate, and wherein the hole and coupling part are configured such that the coupling part comes into contact with the lead tab via the hole.

3. The middle or large sized battery according to claim 2, wherein the coupling part of the conductor plate projects towards an interior of the can.

4. The middle or large sized battery according to claim 1, further comprising a rubber pad disposed between the lateral cap assembly and each of the two opposing sides of the can.

5. The middle or large sized battery according to dam 1, wherein the lead tab is a flexible lead tab haying an adjustable shape.
